(19) United States
(12) Patent Application Publication
(10) Pub. No.: US 2024/0423206 A1
(43) Pub. Date: Dec. 26, 2024

(54) HERBICIDE TRANSPORT SYSTEM

(71) Applicant: Syngent Crop Protection AG, Basel (CH)

(72) Inventors: Philip Lamers, Munchwilen (CH); Nathalie Scheuble, Munchwilen (CH); Philippe Blind, Munchwilen (CH)

(73) Assignee: Syngenta Crop Protection AG, Basel (CH)

(21) Appl. No.: 18/700,507

(22) PCT Filed: Oct. 10, 2022
(86) PCT No.: PCT/EP2022/078026

§ 371 Date: Apr. 11, 2024

(30) Foreign Application Priority Data
Oct. 22, 2021 (EP) 21204229.5

(51) Int. Cl. A01N 43/90; A01N 25/02; A01N 25/24; A01P 13/00

(52) U.S. Cl. CPC A01N 43/90; A01N 25/02; A01N 25/24; A01P 13/00

(57) ABSTRACT

A transport system comprising a suitable container containing a composition consisting essentially of pinoxaden and an ester, a ketone and/or an alcohol, a composition essentially consisting of pinoxaden and an ester, a ketone and/or an alcohol and a method of reducing or eliminating the risk of pinoxaden powder becoming airborne which comprises adding an ester, a ketone and/or an alcohol to the pinoxaden powder and thoroughly mixing it to form a homogeneous composition.

The present invention relates to a storage and transport system for a known herbicide, pinoxaden, which is safer than known methods. It also relates to stable, high strength compositions of pinoxaden useful in the system and to methods of making them.

Pinoxaden is well known and widely used herbicide, details of which can be found at entry 694 on page 902-903 of The Pesticide Manual 16^{th} Edition, published by BCPC in 2012. Commercial formulations of pinoxaden are available under the brand name Axial from Syngenta Crop Protection AG, and samples of the compound can be obtained from various suppliers such as Sigma-Aldrich.

Commercial formulations of pinoxaden are generally in the form of emulsifiable concentrates (ECs). Pinoxaden ECs comprise pinoxaden dissolved in a suitable solvent together with surfactants. The EC is diluted with water by the end user (usually a farmer) and applied to a field by spraying.

Commercial formulations of pinoxaden generally have a low oral, dermal and inhalation toxicity. However, when pinoxaden itself is manufactured, it is produced as a fine powder. A known and significant problem with pinoxaden is that the powdered form of the compound is a respiratory sensitizer. That means that if a person repeatedly inhales pinoxaden dust from the atmosphere, this can cause serious asthma-like symptoms related to pulmonary oedema and pneumonitis.

Typically, pinoxaden is made in a chemical manufacturing plant, then packaged and transported to a formulation plant having specialist formulation equipment that is frequently at a different location, sometimes in a different country, for incorporating into a formulated product. It is packaged in the manufacturing plant into transport containers which are typically drums or Intermediate Bulk Containers (IBC) of between around 500 and 10000 litres and transported by a variety of mean such as truck, ship, and airplane to the formulation plant.

Thus, pinoxaden in powdered form poses a safety risk for workers at the manufacturing plant in the final stages of manufacture and packaging. It also poses a risk for workers in formulation plants who may be exposed to the powder when bags of pinoxaden are opened ready to be incorporated into a formulation. There is also potentially a risk to anyone exposed if the transport containers should become damaged and release their contents during transportation.

The inhalation risks associated with manufacturing pinoxaden can be mitigated at the manufacturing plant by the use of containment areas with air curtains and a negative air pressure to reduce the risks of pinoxaden powder being released outside of the containment area. Closed-transfer equipment can be used to transfer the pinoxaden powder from the end of the process into the transport containers. Workers within the containment area wear extensive personal protective equipment including breathing apparatus. Such containment and equipment are standard within many pharmaceutical manufacturing plants, although they are unusual for agrochemical manufacturing and incur a higher than usual capital outlay and running costs.

Similar equipment is also needed at formulation plants where the pinoxaden powder is transferred from its transport container into formulation vessels where it is combined with other formulation components such as solvents, surfactants and adjuvants. Such equipment is less commonly available in formulation plants and represents a considerable additional cost in setting up the plant.

There is clearly a desire to reduce the inhalation hazards associated with pinoxaden transport and formulation. We have found a simple and cost-effective solution to the problem which is to use a transport system comprising a suitable container in which is contained a combination of the pinoxaden powder with an ester, ketone or an alcohol so as to make a homogenous composition, preferably a solution, which reduces or eliminates the risk of pinoxaden powder becoming airborne and posing an inhalation hazard.

According to the present invention there is provided a transport system comprising a suitable container containing a composition consisting essentially of pinoxaden and an ester, a ketone and/or an alcohol.

According to the present invention there is also provided a method of reducing or eliminating the risk of pinoxaden powder becoming airborne which comprise adding an ester or alcohol to the pinoxaden powder and thoroughly mixing it to form a homogeneous composition essentially consisting of pinoxaden and the ester or alcohol.

According to the present invention there is further provided a composition consisting essentially of pinoxaden and an ester, a ketone and/or an alcohol.

By ‘consisting essentially of’ is meant that the composition comprises less than 10% by weight of other components, preferably less than 5% by weight, most preferably less than 1% by weight.

Advantageously, there is provided a composition consisting of pinoxaden and an ester, a ketone and/or an alcohol, and less than 0.9% by weight of any other component.

Preferably the compositions contain only low amounts of other components such as surfactants and additional water-insoluble solvents.

Preferably the compositions contain only low amounts of surfactants, for example 0 to 2% by weight, preferably below 0.4% by weight, most preferably zero. Low or zero amounts of surfactants allow the choice of the nature and amounts of surfactants present in the final EC composition to be made at the time that the formulation is made.

Preferably the compositions comprise only low or zero amounts of additional water-insoluble solvents for example 0 to 5% by weight, most preferably zero. Low or zero amounts of additional solvents allows the broadest choice of the nature and amounts of solvents present in the final EC composition to be made at the time that the formulation is made.

Typical transport containers are made out of metal or plastic and contain between 10 kg and 1000 kg of composition. Preferably the container contains from 100 to 10000 litres of the composition, most preferably from 500 to 5000 litres. Examples of suitable containers are Intermediate Bulk Containers (IBC) which are industry-standard containers usually of around 1000 litres capacity made out of plastic and usually surrounded by a protective metal cage. Other examples are drums.

Pinoxaden is also known to have significant problems with stability (particularly the degradation of the ester linkage of pinoxaden) and solubility with a range of solvents. There is therefore a specific need for the transport system to exhibit the three-way combination of safety, stability and solubility.

Accordingly and preferably the ester, ketone or alcohol is selected from the group consisting of one or more of 2-ethylhexanol, n-octanol, benzyl alcohol, tetrahydrofurfuryl alcohol, 2-methyl-2,4-pentanediol (also known as hexylene glycol), 4-hydroxy-4-methyl-2-pentanone, cyclohexanol, ethyl lactate, 2-ethylhexyl-S-lactate, butyl lactate, gamma-Butyrolactone, 1,2-propylene glycol, propanoic acid, (2,2-Dimethyl-1,3-dioxolan-4-yl) methanol, and methyl-phenyl ketone.

More preferably the ester, ketone or alcohol is an alcohol selected from the group consisting of one or more of benzyl alcohol, tetrahydrofurfuryl alcohol, methyl-phenyl ketone, (2,2-Dimethyl-1,3-dioxolan-4-yl) methanol, gamma-Butyrolactone and 2-methyl-2,4-pentanediol, most preferably selected from benzyl alcohol and 2-methyl-2,4-pentanediol.

Particularly preferred alcohols are either 2-methyl-2,4-pentanediol or a mixture of 2-methyl-2,4-pentanediol and benzyl alcohol.

Where a mixture of 2-methyl-2,4-pentanediol and benzyl alcohol is used, the alcohols are preferably present in a ratio of from 80-20% to 20-80% by weight.

Especially preferred is 2-methyl-2,4-pentanediol. It has surprisingly been found that 2-methyl-2,4-pentanediol demonstrates the most advantageous combination of technical properties of safety, solubility and stability.

The benefit of using the preferred esters or alcohols listed above is that they are already used in making several pinoxaden EC formulations and are known to be compatible with pinoxaden. Thus, the amount of ester or alcohol used in making the composition of the invention can easily be subtracted from the amount used at the formulation plant to make the final EC formulation. Further benefits of the preferred esters or alcohols are that pinoxaden degradation is reduced

Preferably the weight ratio of pinoxaden to ester, ketone or alcohol is from 10:90 to 40:60, more preferably 15:85 to 30:70. A ratio of 15:85 to 28:72 is preferred when the alcohol is 2-methyl-2,4-pentanediol.

Preferably the amount of pinoxaden by weight in the compositions is more than 15% by weight, such as more than 20%, even from 20.1 to 40% by weight, from 21 to 35% by weight, from 22 to 30% by weight, or from 23 to 27% by weight. The upper amount is determined by the maximum solubility of pinoxaden in the ester or alcohol. Preferably the composition is a saturated or supersaturated solution of pinoxaden in the ester or alcohol at temperatures likely to be encountered in use, for example −20° to +30° C., or −10° to +20° C.

A particularly preferred embodiment of the present invention consists essentially of from 24 to 26% by weight of pinoxaden and from 74 to 76% by weight of 2-methyl-2,4-pentanediol.

The compositions of the present invention can be made by combining the components in any order and using mechanical agitation, such as mechanical stirring until the components form a homogeneous mixture. Heat may also be applied to facilitate dissolving of the pinoxaden in the ester or alcohol, for example to between 25° to 65° C., such as from 25 to 50° C., or from 25 to 40° C.

The compositions of the invention can be made as the final step in the manufacturing process for pinoxaden, thus reducing or eliminating operator exposure to any pinoxaden powder. Use of the compositions of the invention reduces or eliminated accidental exposure during storage or transport due to damage to the transport containers. Use of the compositions of the invention reduces or eliminates operator exposure to pinoxaden powder at formulation plants and allows the use of a lower level of operator protection.

Unless otherwise stated, quantities of components in percentages are given as percentages by total weight and all embodiments and preferred features may be combined in any combination.

The invention will now be illustrated by the following Examples.

### EXAMPLES

### Solubility Testing

Pinoxaden (25 g) was added to the respective solvent (75 g) as set out in Table 1 and stirred at 50° C. for 1 hour. After cooling to room temperature (RT) the sample was visually checked for solid residues.

Where there were no residues and the resulting solution was a clear liquid the sample was considered as a “pass”.

The results are set out in Table 1.

TABLE 1

| Chemical Class | Name | Solubility |
|---|---|---|
| Aliphatic Alcohol | 2-methyl-2,4-pentanediol | Pass |
| Aliphatic Alcohol | dipropylenglycol-methylether | Pass |
| Aliphatic Alcohol | n-octanol | Pass |
| Aliphatic Alcohol | benzyl alcohol | Pass |
| Aliphatic Alcohol | 1,2-propylene glycol | Pass |
| Aliphatic Amide | mixture of octanoic acid- decanoic acid-N,N- | Fail |
| | dimethylamide | |
| Aliphatic Amide | lactic acid dimethyl amide | Pass |
| Aliphatic Amide | methyl-5-(dimethylamino)-2-methyl-5- | Fail |
| | oxopentanoate | |
| Aliphatic Amide | N,N-Dimethyl-9-decenamide | Fail |
| Aliphatic Ester | 1,2,3-triacetoxypropane | Fail |
| Aliphatic Ester | 40% w/v in water fatty acid, C14-18 and C16-18- | Fail |
| | unsatd., methyl ester + copolymer vinyl alcohol-vinyl | |
| | acetate | |
| Aliphatic Ester | acetic acid, branched alkyl esters; | Fail |
| | 2-ethylhexyl acetate | |
| Aliphatic Ester | mixture of glutaric-, succinic- and adipic- | Fail |
| | methyl diesters | |
| Aliphatic Ester | C18 fatty acid methyl esters | Fail |
| Aliphatic Ester | Isobornyl-acetate | Fail |
| Aliphatic Ester | benzyl acetate | Fail |
| Aliphatic Ester | 2-ethylhexyl-S-lactate | Pass |
| Aliphatic Ester | lactic acid ethyl ester | Pass |
| Aliphatic Ester | cyclohexanedicarboxylic acid, dinonyl ester | Fail |
| Aliphatic | isoparaffinic solvent | Fail |
| Hydrocarbons | | |
| Aliphatic | isoparaffinic hydrocarbon | Fail |
| Hydrocarbons | | |
| Aliphatic | Solvesso ® 100 (aromatic solvent) | Fail |
| Hydrocarbons | | |
| Amide | mixture of derivatives of formic acid, carbonic acids, | Pass |
| Amide | Dibutylpropionamide | Fail |
| Aromatic Ester | benzyl benzoate | Fail |
| Aromatic Ester | benzoic acid methyl ester | Pass |
| Aromatic Ester | dipropylene glycol dibenzoate | Fail |
| Aromatic | Solvesso ® 200ND | Pass |
| Hydrocarbons | (mixture of aromatic hydrocarbons, naphthalene | |
| | depleted) | |
| Aromatic | Solvesso ® 150 ND (mixture of aromatic hydrocarbons | Fail |
| Hydrocarbons | (C9-C16), naphthalene depleted) | |
| Carbonate | propylene carbonate t | Pass |
| Carbonate | glycerin carbonate | Fail |
| Ester | rapeseed oil me-ester 40% w/v in water | Fail |
| Alcohol | (2,2-Dimethyl-1,3-dioxolan-4-yl)methanol | Pass |
| Ketone | methyl-phenyl ketone | Pass |
| Oil | rapeseed oil | Fail |
| Oil | agricultural adjuvant oil | Fail |
| Aliphatic Ester | fatty acids, C6-10, Me esters | Fail |
| Alcohol | Tetrahydrofurfuryl Alcohol | Pass |
| Aliphatic Ester | gamma-Butyrolactone | Pass |

It can be seen that alcohols, the ketone and the esters demonstrate good solubility of pinoxaden.

### Rehomogenisability

The compounds that passed the solubility screening were then tested to determine whether the solutions were rehomogenisable.

The samples were stored for 4 weeks at −18° C. in order to cause the Pinoxaden to crash out of the solution. The samples were then stored for 12 hours at 50° C. After passive cooling to RT the samples were visually checked for any solid residues.

Where there were no residues and the resulting solution was a clear liquid the sample was considered rehomogenisable and the sample was marked as “pass”.

The results are set out in Table 2

TABLE 2

| Chemical Class | Name | Rehomogenisable |
|---|---|---|
| Aliphatic Alcohol | 2-methyl-2,4-pentanediol | Pass |
| Aliphatic Alcohol | Dipropyleneglycol methyl ether | Fail |
| Aliphatic Alcohol | n-octanol | Fail |
| Aliphatic Alcohol | benzyl alcohol | Pass |
| Aliphatic Alcohol | 1,2-propylene glycol | Pass |
| Aliphatic Amide | lactic acid dimethyl amide | Fail |
| Aliphatic Ester | 2-ethylhexyl-S-lactate | Pass |
| Aliphatic Ester | lactic acid ethyl ester | Pass |
| Amide | mixture of derivatives of | Fail |
| | formic acid and carbonic acids, | |
| Aromatic Ester | benzoic acid methyl ester | Fail |
| Aromatic | Solvesso ® 200ND (mixture of aromatic | Fail |
| Hydrocarbons | hydrocarbons, naphthalene depleted) | |
| Carbonate | propylene carbonate | Fail |
| Alcohol | (2,2-Dimethyl-1,3-dioxolan-4-yl)methanol | Pass |
| Ketone | methyl-phenylketone | Pass |
| Alcohol | Tetrahydrofurfuryl Alcohol | Pass |
| Aliphatic Ester | gamma-Butyrolactone | Pass |

Table 2 demonstrates that the pinoxaden compositions comprising alcohols, the ketone and the esters were and are capable of being rehomogenised.

### Chemical Stability

Accordingly, those compounds that were capable of being rehomogenised were tested for chemical stability, specifically the level of pinoxaden degradation.

The compositions were stored for 2 and 4 weeks at elevated temperatures (54° C.) after which the loss of Pinoxaden was determined. The loss was calculated in comparison to a reference sample that was stored for the same period at a temperature of −18° C. and the relative degradation is given in %.

The pinoxaden content was determined by using a high-performance liquid chromatography (HPLC) method. Samples showing a degradation of less than 3% were considered as “pass”.

The results are set out in Table 3.

TABLE 3

| Chemical | | | Pass/ | | Pass/ |
|---|---|---|---|---|---|
| Class | Name | 2 weeks | Fail | 4 weeks | Fail |
| Aliphatic | 2-methyl-2,4- | −1.65% | Pass | −2.07% | Pass |
| Alcohol | pentanediol | | | | |
| Aliphatic | benzyl alcohol | −3.28% | Fail | −5.35% | Fail |
| Alcohol | | | | | |
| Aliphatic | 1,2-propylene glycol | −4.17% | Fail | −6.30% | Fail |
| Alcohol | | | | | |
| Aliphatic | 2-ethylhexyl-S-lactate | −5.49% | Fail | −8.90% | Fail |
| Ester | | | | | |
| Aliphatic | lactic acid ethyl ester | −3.06% | Fail | −8.19% | Fail |
| Ester | | | | | |
| Alcohol | (2,2-Dimethyl-1,3- | −2.06% | Pass | −3.32% | Fail |
| | dioxolan-4- | | | | |
| | yl)methanol | | | | |
| Ketone | methyl-phenylketone | −1.26% | Pass | −4.60% | Fail |
| Alcohol | Tetrahydrofurfuryl | −11% | Fail | −16% | Fail |
| | Alcohol | | | | |
| Aliphatic | gamma-Butyrolactone | −1.67% | Pass | −3.75% | Fail |
| Ester | | | | | |

The results demonstrate that alcohols, esters and ketone are effective in preventing pinoxaden degradation, with 2-methyl-2,4-pentanediol performing particularly well across all tests.

### Transport System

Compositions comprising 2-methyl-2,4-pentanediol and/or benzyl alcohol were successfully prepared as transport systems that satisfy the criteria of safety, stability and solubility while also containing a very high loading of pinoxaden. The transport systems are set out in Table 4.

TABLE 4

| | 2-methyl-2,4- | | | | | | Pinoxaden |
|---|---|---|---|---|---|---|---|
| Composition | pentanediol | | Benzyl alcohol | | Pinoxaden | | % by weight |
| 1 | 62.5 | g | 187.5 | g | 250 | g | 50% |
| 2 | 150 | g | 150 | g | 200 | g | 40% |
| 3 | 162.5 | g | 162.5 | | 175 | g | 35% |
| 4 | 243.75 | g | 81.25 | g | 175 | g | 35% |
| 5 | 262.5 | g | 87.5 | g | 150 | g | 30% |

| | | | | | | |
|---|---|---|---|---|---|---|
| 6 | 320 | g | 0 | 80 | g | 20% |

The invention is defined by the claims.

1. A transport system comprising a suitable container containing a composition consisting essentially of pinoxaden and an ester, a ketone and/or an alcohol.

2. The transport system as claimed in claim 1 in which the container is an IBC.

3. The transport system as claimed in claim 1 in which the container has a capacity between 100 litres and 10000 litres.

4. A composition consisting essentially of pinoxaden and an ester, a ketone and/or or alcohol.

5. The composition according to claim 4 in which the ester or alcohol is selected from the group consisting of one or more of 2-ethylhexanol, n-octanol, benzyl alcohol, tetrahydrofurfuryl alcohol, 2-methyl-2,4-pentanediol, 4-hydroxy-4-methyl-2-pentanone, cyclohexanol, ethyl lactate, 2-ethylhexyl-S-lactate, butyl lactate, 1,2-propylene glycol, propanoic acid, (2,2-Dimethyl-1,3-dioxolan-4-yl) methanol, gamma-Butyrolactone and methyl-phenyl ketone.

6. The composition according to claim 4 in which the ester or alcohol is an alcohol selected from the group consisting of one or more of benzyl alcohol, tetrahydrofurfuryl alcohol, gamma-Butyrolactone, methyl-phenylketone, (2,2-Dimethyl-1,3-dioxolan-4-yl) methanol and 2-methyl-2,4-pentanediol.

7. The composition according to claim 4 in which the alcohol is selected from the group consisting of 2-methyl-2,4-pentanediol and a mixture of 2-methyl-2,4-pentanediol and benzyl alcohol.

8. The composition according to claim 4 in which the alcohol is selected from the group consisting of a mixture of 2-methyl-2,4-pentanediol and benzyl alcohol in a ratio of 80-20 to 20-80% by weight.

9. The composition of claim 7 in which the alcohol is 2-methyl-2,4-pentanediol.

10. The composition according to claim 4 in which the weight ratio of pinoxaden to ester, ketone or alcohol to 10:90 to 40:60.

11. The composition according to claim 4 in which the weight ratio of pinoxaden to ester, ketone or alcohol is 15:85 to 30:70.

12. The composition according to claim 4 in which the amount of pinoxaden by weight is more than 20%.

13. A method of reducing or eliminating the risk of pinoxaden powder becoming airborne which comprises adding an ester or alcohol to the pinoxaden powder and thoroughly mixing it to form a homogeneous composition as claimed in any of the preceding claims.
